(19) United States
(12) Patent Application Publication
(10) Pub. No.: US 2016/0153350 A1
(43) Pub. Date: Jun. 2, 2016

(54) Method and apparatus for operating an electric-motor-assisted exhaust turbocharger of a motor vehicle

(71) Applicant: MAN Truck & Bus AG, Munchen (DE)

(72) Inventors: Andreas PAPPENHEIMER, Nurnberg (DE); Andreas SOMMERMANN, Heilsbronn (DE)

(21) Appl. No.: 14/951,092

(22) Filed: Nov. 24, 2015

(30) Foreign Application Priority Data
Nov. 28, 2014 (DE) 10 2014 017 631.2

(51) Int. Cl. F02B 37/14; F01N 5/04; F02B 37/10

(52) U.S. Cl. CPC F02B 37/14; F02B 37/10; F01N 5/04

(57) ABSTRACT

An electric-motor-assisted exhaust turbocharger of a motor vehicle includes an exhaust turbocharger having a first electric machine. A low-voltage on-board electrical system with a second electric machine can be operated as a motor and as a generator and can be coupled for torque transmission to the crankshaft, and an electric energy storage device supplies the electric loads arranged in the low-voltage on-board electrical system. A control unit controls the first electric machine in a first operating mode to drive the exhaust turbocharger, and controls the first electric machine in a second operating mode to recover electric energy from the exhaust-gas energy. The control unit feeds electric energy from the low-voltage on-board electrical system to the exhaust turbocharger in the first operating mode and feeds the recovered electric energy into the low-voltage on-board electrical system in the second operating mode.

### CROSS-REFERENCE TO RELATED APPLICATIONS

The present application claims priority of DE 10 2014 017 6312 filed Nov. 28, 2014, which is incorporated herein by reference.

### BACKGROUND OF THE INVENTION

The invention relates to a method for operating an electric-motor-assisted exhaust turbocharger and to an apparatus for operating an electric-motor-assisted exhaust turbocharger.

It is known from practical experience that an exhaust turbocharger can be embodied as an electric-motor-assisted exhaust turbocharger. In this case, an additional electric motor is provided for driving or assisting the driving of the exhaust turbocharger, which electric motor can be coupled or is coupled for torque transmission to the drive shaft of the exhaust turbocharger. With an additional electric motor of this kind, the pressure-charging process of the internal combustion engine can be temporarily assisted. The basic concept consisted in decoupling the run-up of the rotor assembly, which is responsible for the delayed response, from the thermodynamic dependence and bringing about the speed increase primarily by of the electric motor. As a result, the turbocharger speed would be largely independent of the crankshaft speed.

In connection with hybridized drive trains, it has furthermore been proposed to use the electric motor of the exhaust turbocharger to recover some of the exhaust-gas energy in operating states with sufficient exhaust-gas energy by operating the electric motor as a generator and, for this purpose, to store the recovered energy in the electric high-voltage energy storage device for the electric-motor driving of the vehicle. In the article “Hybridturbolader mit neuer Elektrornotorentechnik” [Hybrid Turbochargers with New Electric Motor Technology] on pages 50-55 of the 3/2014 edition of the journal “MTZ—Motortechnische Zeitschrift”, there is likewise a proposal to use the electric motor of the exhaust turbocharger to recover some of the exhaust-gas energy in operating states with sufficient exhaust-gas energy by operating the electric motor as a generator and, for this purpose, to provide an additional electric energy storage device to store the recovered energy. An illustrative embodiment of an exhaust turbocharger that can be operated in motor and in generator mode is furthermore described. The disadvantage with the abovementioned approaches to energy recovery with the aid of an electric-motor-assisted exhaust turbocharger is that they cannot be used for motor vehicles driven exclusively by internal combustion engine or that they require the provision of an additional energy storage device.

### BRIEF SUMMARY OF THE INVENTION

An object of the invention is to provide an improved method and apparatus for operating an electric-motor-assisted exhaust turbocharger that avoids disadvantages of conventional technologies. In particular, it is an object of the invention to provide an operating method for an electric-motor-assisted exhaust turbocharger in which some of the exhaust-gas energy can be recovered in operating states with sufficient exhaust-gas energy by operating the electric motor as a generator and which can also be used on motor vehicles driven exclusively by internal combustion engine, i.e., on vehicles without a hybridized drive train, in a simpler and more cost-saving configuration.

According to an embodiment of the invention, a method for operating an electric-motor-assisted exhaust turbocharger of a motor vehicle, in particular a commercial vehicle, is proposed, comprising a first operating mode, in which the exhaust turbocharger is driven with electric-motor assistance, and a second operating mode, in which the exhaust turbocharger recovers electric energy from the exhaust-gas energy. The motor vehicle is preferably a motor vehicle driven by internal combustion engine without a hybrid drive or is a mild-hybrid vehicle, in which an electric machine assists the internal combustion engine in motor mode in order to increase power and reduce consumption and in which braking energy is partially recovered in the generator mode of the electric machine.

According to general aspects of the invention, in the first operating mode, electric energy from a low-voltage on-board electrical system of the motor vehicle is fed to the exhaust turbocharger and, in the second operating mode, the electric energy recovered by the exhaust turbocharger is fed into the low-voltage on-board electrical system without prior intermediate storage.

Thus, the invention comprises the general technical teaching that the existing conventional low-voltage on-board electrical system of the motor vehicle is used to provide the electric energy for the exhaust turbocharger and to receive the recovered electric energy from the exhaust turbocharger, with the result that there is no need for an additional high-voltage system with an electric high-voltage storage device or other additional electric energy storage devices. The low-voltage on-board electrical system, also referred to as an I.v. on-board electrical system, is taken to mean a conventional low-voltage on-board electrical system of a motor vehicle which is operated at a rated voltage of up to 60V, e.g., at a rated voltage of 12 V for passenger vehicles, 24 V for commercial vehicles or 48 V for electric or hybrid vehicles. The partial recovery of the exhaust-gas energy by the driving of the exhaust turbocharger by electric motor reduces the fuel consumption and hence CO2 emissions of the motor vehicle.

In one embodiment according to the invention, the electric energy recovered by the exhaust turbocharger is fed to an electric energy storage device which is present in the low-voltage on-board electrical system and which supplies or can supply the electric loads of the low-voltage on-board electrical system. This electric energy storage device is preferably the starter battery. This offers the advantage that no additional energy storage device is necessary to receive the recovered energy but the already existing storage device is used.

The electric energy recovered by the exhaust turbocharger can furthermore be fed to an electric machine which is present in the low-voltage on-board electrical system, can be operated as an electric motor and as a generator, and can be coupled or is coupled for torque transmission to the crankshaft, the electric energy being used to operate the electric machine as an electric motor. This machine can be the alternator, for example. According to this variant, the alternator is thus embodied in such a way and controlled by a control unit in such a way that it is not only driven conventionally as a generator by the internal combustion engine but can also be operated as an electric motor. According to another variant, the electric machine that can be operated as an electric motor and as a generator can be a crankshaft starter generator.

In an embodiment according to the invention, in full-load or high-load operation of an internal combustion engine of the motor vehicle, the exhaust turbocharger is operated in the second operating mode and the electric machine, preferably the alternator, is operated with the recovered energy.

These embodiments offer the particular advantage that a conventional internal combustion engine acts as a microhybrid arrangement in combination with the electric-motor-assisted exhaust turbocharger since recovered exhaust-gas energy can be converted into electric energy, fed directly to an existing electric machine of a drive train for an internal combustion engine, and can be used to increase the power and reduce the consumption of the internal combustion engine without intermediate storage and without a high-voltage system.

The method can furthermore be embodied in such a way that, in the second operating mode, the exhaust turbocharger assists the alternator or the crankshaft starter generator in the charging of the electric energy storage device, preferably if a charge state of the electric energy storage device has fallen below a predetermined threshold value. Thus, the energy recovered by the exhaust turbocharger can be fed directly to the starter battery if the starter battery has been discharged, for example.

The method can furthermore be embodied in such a way that, in transient operating states of the internal combustion engine, the exhaust turbocharger is operated in the first operating mode, i.e., with electric-motor assistance, wherein the energy for electric-motor operation of the exhaust turbocharger is fed to the latter exclusively from the low-voltage on-board electrical system of the vehicle, e.g., from the starter battery of the vehicle. Transient operating states are non-steady-state operating states, e.g., a starting process or a shifting process, in which the exhaust-gas energy/quantity fed to the turbine of the exhaust turbocharger fluctuates greatly. In these transient operating states, the electric motor of the exhaust turbocharger thus compensates for the fluctuations in the exhaust-gas energy/quantity with electric energy from the low-voltage on-board electrical system through operation as a motor (“boost” mode).

In part-load operation and/or overrun operation, the electric machine of the exhaust turbocharger can be operated either as a motor or as a generator, depending on the design, e.g., in dependence on further operating parameters, such as the boost pressure. Since there is not sufficient recoverable exhaust-gas energy available in these operating states, the method is embodied in such a way that the vehicle battery is charged exclusively by the alternator.

The invention also relates to an apparatus for operating an electric-motor-assisted exhaust turbocharger of a motor vehicle, in particular a commercial vehicle. The apparatus comprises an exhaust turbocharger having an exhaust turbine and a compressor, which are connected in terms of motion by a drive shaft. The exhaust turbocharger has electric-motor assistance and, for this purpose, has a first electric machine, which can be operated as a motor and as a generator, can be coupled or is coupled for torque transmission to the drive shaft of the exhaust turbocharger, and is provided for driving or assisting the driving of the exhaust turbocharger. The apparatus furthermore comprises a low-voltage on-board electrical system, in which a second electric machine, which can be operated as a motor and as a generator and can be coupled or is coupled for torque transmission to the crankshaft, and an electric energy storage device for supplying the electric loads arranged in the low-voltage on-board electrical system are provided. The apparatus furthermore comprises a control unit, which is designed to control the first electric machine of the exhaust turbocharger in a first operating mode in order to drive the exhaust turbocharger with electric-motor assistance, and to control the first electric machine in a second operating mode in order to recover electric energy from the exhaust-gas energy by operation as a generator. The apparatus can be a commercial vehicle driven exclusively by an internal combustion engine or a commercial vehicle with a mild-hybrid drive.

According to general aspects of the invention, the control unit is furthermore designed to feed electric energy from the low-voltage on-board electrical system of the motor vehicle to the exhaust turbocharger in the first operating mode and to feed the electric energy recovered by the exhaust turbocharger into the low-voltage on-board electrical system without prior intermediate storage in the second operating mode. The control unit is furthermore designed to carry out the method as disclosed above. To avoid repetitions, features disclosed purely in terms of method shall be deemed to have been disclosed and to be claimable also in terms of apparatus.

It should furthermore be mentioned that an electric turbocompound (ETC), the recovered electric energy of which is fed in a similar way to the low-voltage on-board electrical system, can also be used as a device for recovering exhaust-gas energy instead of an exhaust turbocharger with an electric motor. An electric turbocompound (ETC) comprises an exhaust turbine coupled to a generator. Alternatively, a “waste heat recovery system” (WHR system) can furthermore be used for recovery. A WHR system comprises a heat exchanger, in which water or some other liquid is evaporated by the heat of the exhaust gases. This steam then drives a turbine, which supplies electric power.

### BRIEF DESCRIPTION OF THE DRAWINGS

The above-described preferred embodiments and features of the invention can be combined in any desired manner with one another. Further details and advantages of the invention are described below with reference to the attached drawings, in which:

FIG. 1 is a schematic block diagram of an apparatus for operating an electric-motor-assisted exhaust turbocharger according to one embodiment of the invention;

FIG. 2 is a flow chart of the method for operating an electric-motor-assisted exhaust turbocharger according to one embodiment of the invention; and

FIG. 3 is an engine operating map illustrating a full-load and high-load operating state.

### DETAILED DESCRIPTION OF THE PREFERRED EMBODIMENTS

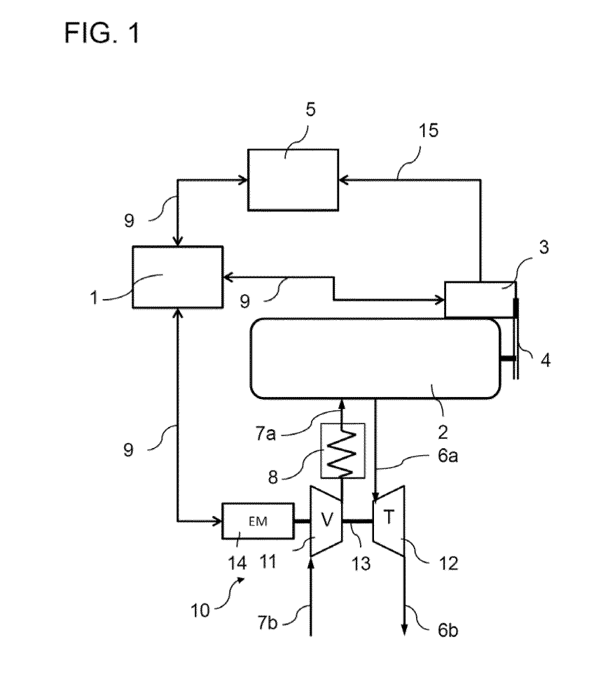

An apparatus for operating an electric-motor-assisted exhaust turbocharger according to one embodiment of the invention is shown in the form of a block diagram in FIG. 1. Here, only those components which are necessary for the understanding of the invention are shown. The apparatus comprises a pressure-charged internal combustion engine 2 and an electric-motor-assisted exhaust turbocharger (ET) 10 associated therewith. The electric-motor-assisted exhaust turbocharger 10 comprises a turbine 12, which is driven by the exhaust gas from the internal combustion engine 2, which is fed to the turbine via the exhaust line 6a. After this, the exhaust-gas mixture flows via the turbine outlet 6b into the exhaust. The turbine 12 is connected to a compressor 11 by a shaft 13. Fresh air is fed to the compressor via the compressor inlet 7b. The compressor 11 compresses the charge air to be fed to the internal combustion engine 2 and thus boosts the power of the internal combustion engine 2. The charge air compressed by the compressor 11 is fed via a charge air line 7a to a charge air cooler 8 and is then fed into the internal combustion engine 2.

The ET 10 is embodied as an electric-motor-assisted exhaust turbocharger. For this purpose, the ET 10 is provided with an electric machine 14, which can be operated as a motor and as a generator, can be coupled or is coupled for torque transmission to the drive shaft 13 and is provided for driving or assisting the driving of the other components 11 to 13 of the exhaust turbocharger.

The operation of the electric motor 14 as a motor and as a generator is controlled by a control unit 1. The control unit 1 is furthermore designed to control the operation of an alternator 3, which is arranged in the 24 V low-voltage on-board electrical system of the vehicle. The alternator 3 can be coupled or is coupled for torque transmission to the crankshaft, in the present case by means of a belt drive 4, for example. In particular, the control unit 1 is designed to operate the alternator 3 either as a motor or as a generator, wherein the alternator 3 is driven by the internal combustion engine 2 in the conventional generator mode. In this case, the power produced can be fed to a starter battery 5 arranged in the low-voltage on-board electrical system, this being illustrated by the electric line 15. Further electric loads (not shown) in the low-voltage on-board electrical system can be supplied electrically in a manner known per se by the alternator 3 and the starter battery 5. The power which is produced in generator mode can furthermore be fed via the control unit 1 to the electric machine 14 of the ET 10 in order to operate the latter in motor mode, this being illustrated by electric lines 9.

One special feature of the teaching according to the invention is that the alternator 3 can also be operated as a motor by the control unit 1. In this operating mode, the alternator 3 is supplied with electric energy, which is produced by the electric machine 14 of the ET 10 when the latter is being operated in the recovery mode. The direction of energy transfer between the alternator 3 and the electric machine 14 of the ET 10 changes depending on the operating mode of the ET 10, i.e., generator or motor mode, this being illustrated by the double arrows on electric lines 9 and 15.

The control unit 1 is furthermore designed to transfer energy bidirectionally between the electric machine 14 of the ET 10 and the starter battery 5 as well when required, in order, for example, to assist the alternator 3 in the charging process when the starter battery 5 has been discharged.

The control unit 1 designed to control the electric machine 14 of the ET 10 by programming and/or by control electronics comprises power electronics for the electric energy transfer from the ET 10 to the low-voltage on-board electrical system and from the low-voltage on-board electrical system to the ET 10, said power electronics being connected by the abovementioned electric connecting lines 9 to the electric machine 14 of the ET 10, the alternator 3 and the starter battery 5.

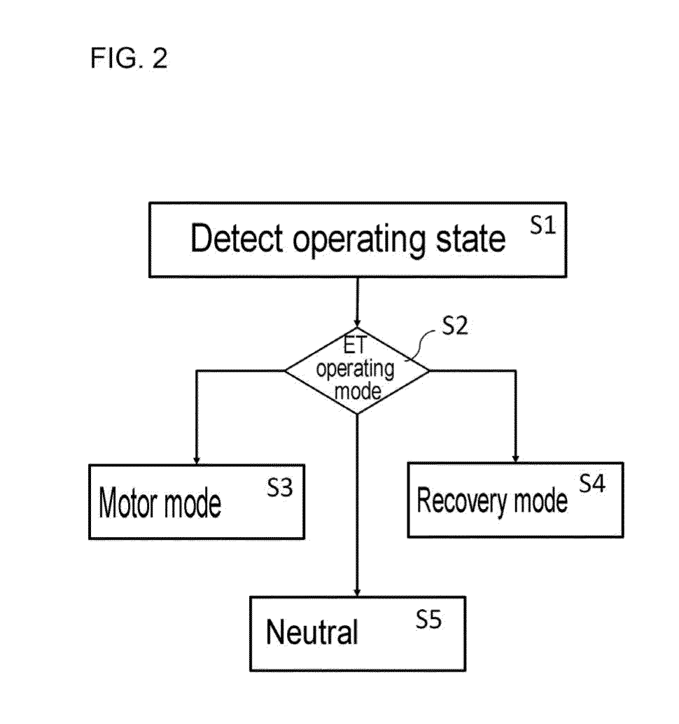

FIG. 2 shows a flow chart of the method for operating the ET 10 according to one embodiment of the invention. In step S1, the control unit 1 continuously determines the current operating state of the vehicle. A current operating state can be determined from the current speed of the internal combustion engine 2, a currently required engine torque and/or a current boost pressure, for example.

Depending on the operating state determined, the control unit decides in step S2 in which operating mode the electric machine 14 of the ET 10 is being operated.

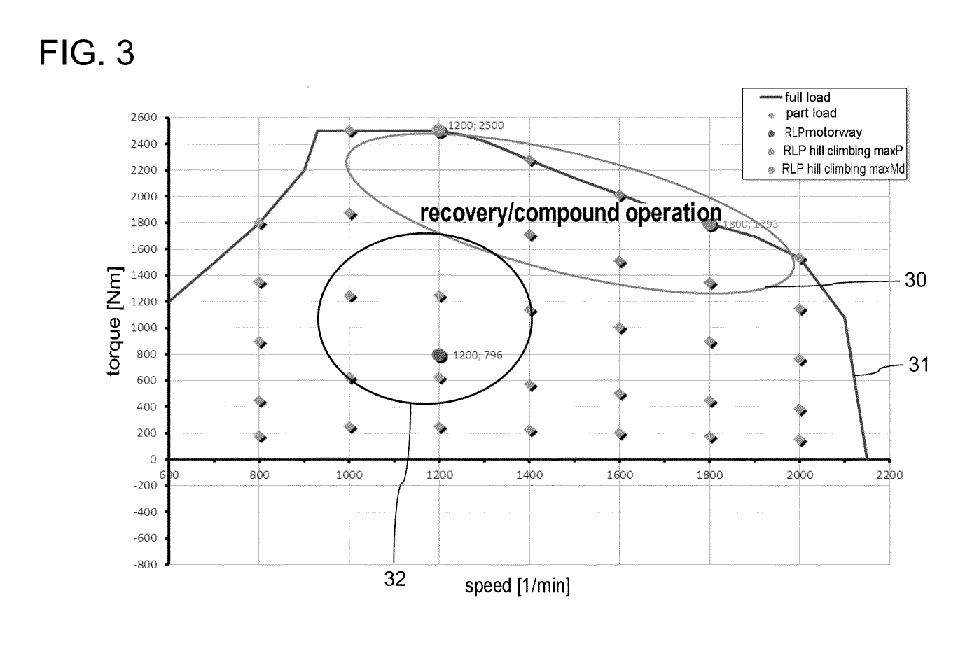

If the vehicle is in full-load or high-load operation, the control unit 1 controls the electric machine 14 in such a way in step S4 that said machine is operated as a generator and the ET 10 is operated in recovery mode. Operating states in full-load or high-load operation are, for example, those operating points which are circled in FIG. 3 by the line indicated by reference sign 30. Here, FIG. 3 shows an engine operating map which indicates the engine operating state in the form of the current torque as a function of the engine speed. Here, the solid line 31 indicates the limiting curve at full load, i.e., the maximum possible torque of the internal combustion engine 2 at full load for a given engine speed of the internal combustion engine 2. A main driving range, which occurs frequently in time, is furthermore indicated by the circular line 32 in FIG. 3. Here too, it may be possible, depending on the design and on operation, to recover energy, even if at lower power in comparison with full load. The overall design aim is to extend the recovery ranges in the engine operating map as far as possible.

Part-load recovery can also be enforced by actuators on the engine (exhaust gas recirculation, variable turbine geometry, wastegate), while taking account of the engine parameters.

As already mentioned above, the energy recovered by the ET 10 is fed to the low-voltage on-board electrical system by the power electronics of the control unit 1 directly, without an intermediate storage device, e.g. in order to operate the alternator 3 as an electric motor, thereby enabling the internal combustion engine 2 to be assisted.

If a transient operating state of the internal combustion engine 2 is detected, e.g., a starting or shifting process, the exhaust turbocharger is operated with electric-motor assistance (step S3). The control unit 1 makes available the electric energy required for this purpose exclusively from the low-voltage on-board electrical system of the vehicle, e.g., from the starter battery 5 or the alternator 3 of the vehicle.

In part-load operation and/or overrun operation, the electric machine 14 of the exhaust turbocharger 10 can be operated either as a motor (step S3), as a generator (step S4) or neutrally, i.e., without energy being supplied or removed (step S5), depending on the design.

If it is furthermore detected in step S2 that the starter battery has been discharged or that the charge state thereof has fallen below a predetermined threshold value, the control unit 1 feeds the electric energy recovered by the ET 10 in the recovery mode directly to the starter battery 5 in order to assist the alternator 3 in charging the starter battery 5.

The invention is not restricted to the preferred illustrative embodiments described above. On the contrary, a large number of variants and modifications is possible that likewise make use of the inventive concept and therefore fall within the scope of protection. In particular, the invention also claims protection for the subject matter and features of the dependent claims independently of the claims to which they refer.

### LIST OF REFERENCE SIGNS

1 control unit
2 internal combustion engine
3 alternator
4 belt drive
5 starter battery
6a turbine inlet
6b turbine outlet
7a compressor outlet or charge air line
7b compressor inlet
8 charge air cooler
9 electric line
10 exhaust turbocharger
11 compressor
12 turbine
13 drive shaft
14 electric machine
15 electric line
30 high-load operation
31 full-load limiting curve of the engine operating map
32 main driving range

1. A method for operating an electric-motor-assisted exhaust turbocharger of a motor vehicle, comprising the steps of
operating the exhaust turbocharger in a first operating mode, in which the exhaust turbocharger is driven with electric-motor assistance, and
operating the exhaust turbocharger a second operating mode, in which the exhaust turbocharger recovers electric energy from the exhaust-gas energy,
wherein, in the first operating mode, electric energy from a low-voltage on-board electrical system of the motor vehicle is fed to the exhaust turbocharger and, in the second operating mode, the electric energy recovered by the exhaust turbocharger is fed into the low-voltage on-board electrical system without prior intermediate storage.

2. The method according to claim 1, wherein the motor vehicle is a commercial vehicle.

3. The method according to claim 1, wherein the electric energy recovered by the exhaust turbocharger is at least one of
fed to an electric energy storage device present in the low-voltage on-board electrical system, the electric energy storage device configured to supply electric loads of the low-voltage on-board electrical system; and
fed to an electric machine, which is present in the low-voltage on-board electrical system and can be operated as an electric motor and as a generator, to operate the electric machine as an electric motor.

4. The method according to claim 3, wherein the electric energy storage device is the starter battery.

5. The method according to claim 3, wherein the electric machine, which can be operated as an electric motor and as a generator, is an alternator or a crankshaft starter generator.

6. The method according to claim 5, wherein, in a full-load operation or a high-load operation of the internal combustion engine, the exhaust turbocharger is operated in the second operating mode and the electric machine is operated with the recovered energy.

7. The method according to claim 5, wherein, in the second operating mode, the exhaust turbocharger assists the alternator or the crankshaft starter generator in the charging of the electric energy storage device if a charge state of the electric energy storage device has fallen below a predetermined threshold value.

8. The method according to claim 1, wherein, in transient operating states of the internal combustion engine, the exhaust turbocharger is operated with electric-motor assistance in the first operating mode, and the energy for electric-motor operation of the exhaust turbocharger is fed to the exhaust turbocharger exclusively from the low-voltage on-board electrical system of the vehicle.

9. The method according to claim 1, wherein the motor vehicle is a mild-hybrid vehicle or a motor vehicle driven by the internal combustion engine without a hybrid drive.

10. An apparatus for operating an electric-motor-assisted exhaust turbocharger of a motor vehicle, comprising:
an exhaust turbocharger having an exhaust turbine and a compressor, a drive shaft connecting the exhaust turbine and the compressor in terms of motion, and a first electric machine operable as a motor and as a generator and which is provided for driving or assisting the driving of the exhaust turbocharger;
a low-voltage on-board electrical system with a second electric machine operable as a motor and as a generator, the second electric machine being coupleable or coupled for torque transmission to a crankshaft of an internal combustion engine of the motor vehicle, and an electric energy storage device supplying the electric loads arranged in the low-voltage on-board electrical system; and
a control unit controlling the first electric machine of the exhaust turbocharger in a first operating mode in which the exhaust turbocharger is driven with electric-motor assistance, and in a second operating mode in which electric energy from the exhaust-gas energy is recovered by operation of the first electric machine as a generator;
wherein the control unit is designed to feed electric energy from the low-voltage on-board electrical system of the motor vehicle to the exhaust turbocharger in the first operating mode and to feed the electric energy recovered by the exhaust turbocharger into the low-voltage on-board electrical system without prior intermediate storage in the second operating mode.

11. The apparatus according to claim 10, wherein the drive shaft of the exhaust turbocharger is one of:
coupleable or coupled for torque transmission to first electric machine, and
identical with the shaft of the first electric machine.

12. An apparatus for operating an electric-motor-assisted exhaust turbocharger of a motor vehicle, comprising:
an exhaust turbocharger having an exhaust turbine and a compressor, a drive shaft connecting the exhaust turbine and the compressor in terms of motion, and a first electric machine operable as a motor and as a generator and which is provided for driving or assisting the driving of the exhaust turbocharger;
a low-voltage on-board electrical system with a second electric machine operable as a motor and as a generator, the second electric machine being coupleable or coupled for torque transmission to a crankshaft of an internal combustion engine of the motor vehicle, and an electric energy storage device supplying the electric loads arranged in the low-voltage on-board electrical system; and
a control unit controlling the first electric machine of the exhaust turbocharger in a first operating mode in which the exhaust turbocharger is driven with electric-motor assistance, and in a second operating mode in which electric energy from the exhaust-gas energy is recovered by operation of the first electric machine as a generator;
wherein the control unit is designed to feed electric energy from the low-voltage on-board electrical system of the motor vehicle to the exhaust turbocharger in the first operating mode and to feed the electric energy recovered by the exhaust turbocharger into the low-voltage on-board electrical system without prior intermediate storage in the second operating mode,
and the control unit is configured to perform the method of claim 3.
